(19) United States
(12) Patent Application Publication
(10) Pub. No.: US 2026/0236577 A1
(43) Pub. Date: Aug. 13, 2026

(54) MACHINE LEARNING MODEL SECURITY AND CONTENT AUTHORIZATION

(71) Applicant: Cisco Technology, Inc., San Jose, CA (US)

(72) Inventors: Arjun Sambamoorthy, San Jose, CA (US); Chetan Anand, Mountain View, CA (US); Anand Raghavan, Santa Clara, CA (US)

(21) Appl. No.: 19/233,032

(22) Filed: Jun. 10, 2025

Related U.S. Application Data
(60) Provisional application No. 63/755,542, filed on Feb. 7, 2025.

(51) Int. Cl. G06F 21/55; G06F 21/57

(52) U.S. Cl. CPC G06F 21/554; G06F 21/577; G06F 2221/033

(57) ABSTRACT

Disclosed are systems, apparatuses, processes, and computer-readable media for generating protective services for machine learning (ML) models. For example, a disclosed method includes providing a sandboxed environment including an ML model; applying adverse prompts to the ML model that are known to provide an undesirable response; receiving response to the adverse prompt from the machine learning model; determining a portion of the responses corresponding to an undesirable response from a collection of undesirable responses; determining a plurality of embeddings associated with prompts to exclude corresponding to the portion of the responses; and generating a pattern or an ML model configured to identify the plurality of embeddings corresponding to adverse responses.

### CROSS REFERENCE TO RELATED APPLICATIONS

This application claims priority to U.S. Patent Application No. 63/755,542, filed Feb. 7, 2025, entitled “MACHINE LEARNING MODEL SECURITY AND CONTENT AUTHORIZATION” which is incorporated by reference herein in its entirety.

### TECHNICAL FIELD

The disclosure relates generally to network security, and more specifically a methods for machine learning (ML) model security and content authorization.

### BACKGROUND

Network security is a critical aspect of modern digital infrastructure, ensuring that data, applications, and systems remain protected from unauthorized access, cyber threats, and malicious activities. Traditionally, network security relied on perimeter-based defenses like firewalls and intrusion detection systems. However, as networks evolved with cloud computing, microservices, and zero-trust architectures, security approaches shifted towards inline threat detection, where malicious activities are identified and mitigated in real time as traffic flows through the network. Deep Packet Inspection (DPI) and Intrusion Prevention Systems (IPS) are commonly used techniques to identify malware, command-and-control traffic, and policy violations. Additionally, cloud security platforms provide inline threat intelligence, leveraging global threat databases to detect and prevent cyberattacks dynamically. The ability to identify threats inline allows organizations to respond in real-time, enforce security policies proactively, and prevent data breaches before they escalate into significant incidents.

Another important aspect is data loss prevention (DLP) to prevent unauthorized access, transfer, or leakage of sensitive information. Organizations use DLP solutions to detect, monitor, and control data movement across networks, endpoints, and cloud environments, ensuring compliance with regulations like General Data Protection Regulation (GDPR), Health Insurance Portability and Accountability Act (HIPAA), and California Consumer Privacy Act (CCPA). DLP also addresses data exfiltration and attempt to steal sensitive data by bypassing security controls. Data exfiltration can occur through various channels, including phishing attacks, malware, misconfigured cloud storage, external storage devices, encrypted tunnels, or covert domain name server (DNS) traffic.

### BRIEF DESCRIPTION OF THE DRAWINGS

Illustrative embodiments of the present application are described in detail below with reference to the following drawing figures:

FIG. 1 is a conceptual block diagram of an artificial intelligence (AI) defense controller system in accordance with some aspects of the disclosure;

FIG. 2 is a conceptual diagram of an inspection path of the AI defense controller system for ingress and egress traffic in accordance with some aspects of the disclosure;

FIG. 3A is a block diagram of a machine learning (ML) validation system in accordance with some aspects of the disclosure;

FIG. 3B is a conceptual illustration of a signature matching pattern and a signature of a prompt in accordance with some aspects of the disclosure;

FIG. 4 is a block diagram of a validation engine of an ML validation system in accordance with some aspects of the disclosure;

FIG. 5 is a sequence diagram for preventing unauthorized ML model usage in accordance with some aspects of the disclosure;

FIG. 6 is a flowchart illustrating an example process for generating ML authorization information in accordance with some aspects of the disclosure;

FIG. 7 is a diagram illustrating an example of a system for implementing certain aspects of the present technology.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims, or may be learned by the practice of the principles set forth herein.

### Example Embodiments

Examples are described herein in the context of a machine learning (ML) security and content authorization. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

ML, artificial intelligence (AI), and neural networks have evolved due to advances in deep learning, generative AI, and large-scale computing power. Transformer architectures, such as generative pretrained transformer (GPT) and bidirectional encoder representations (BERT) enable more human-like text generation, summarization, and reasoning and allow natural language conversations with machines. These models often are employed for natural language functions such as conversion of unstructured, human readable text into more structured data for various purposes. Other advances include diffusion models with enhanced generative AI to create images, videos, and music audio.

The models that drive services for AI-based functions are not easily deployed on local resources because the models use parallelization of computations, generally with tensor processing units (TPUs), graphics processing units (GPUs), and other neural processing units (e.g., neural engines, neural network processing units (NNPUs), etc.). These services are primarily cloud-native and require the transmission of natural language prompts and corresponding answers to those prompts across the network. The custom training of these models may also require the transmission of significant volumes of data to cause further training or adapters to learn new information within a specialized domain of knowledge.

Conventional network security is typically deployed using firewalls, intrusion detection, and prevention systems, virtual private networks (VPNs), data loss prevention (DLP), and endpoint security tools that rely on signature-based detection, rule-based policies, and manual configurations to identify threats. Network security is analyzed by monitoring traffic patterns, blocking known malicious signatures, and enforcing predefined access controls to protect networks and devices. Modern, AI-powered cyber threats can adapt to and evade signature-based detection, exploit zero-day vulnerabilities, and extract sensitive information from protected networks.

ML models may be distributed across various networks and are subjected to a variety of attacks, including from the model itself to the packaging of the model files. The package of the model includes various metadata and other information to enable a common interface with the ML model through various interfaces. In some cases, the packaging can be compromised to inject malicious acting software to infect devices, steal information, and so forth. ML models can also be poisoned during training with various techniques to leak information for training purposes. In many cases, vulnerabilities associated with ML models can be discovered in production and techniques for protecting the security are important.

Disclosed are systems, apparatuses, methods, computer readable medium, and circuits for generating protective services for ML models. According to at least one example, a method includes: providing a sandboxed environment including an ML model; applying adverse prompts to the ML model that are known to provide an undesirable response; receiving response to the adverse prompt from the machine learning model; determining a portion of the responses corresponding to an undesirable response from a collection of undesirable responses; determining a plurality of embeddings associated with prompts to exclude corresponding to the portion of the responses; and generating a pattern or an ML model configured to identify the plurality of embeddings corresponding to adverse responses.

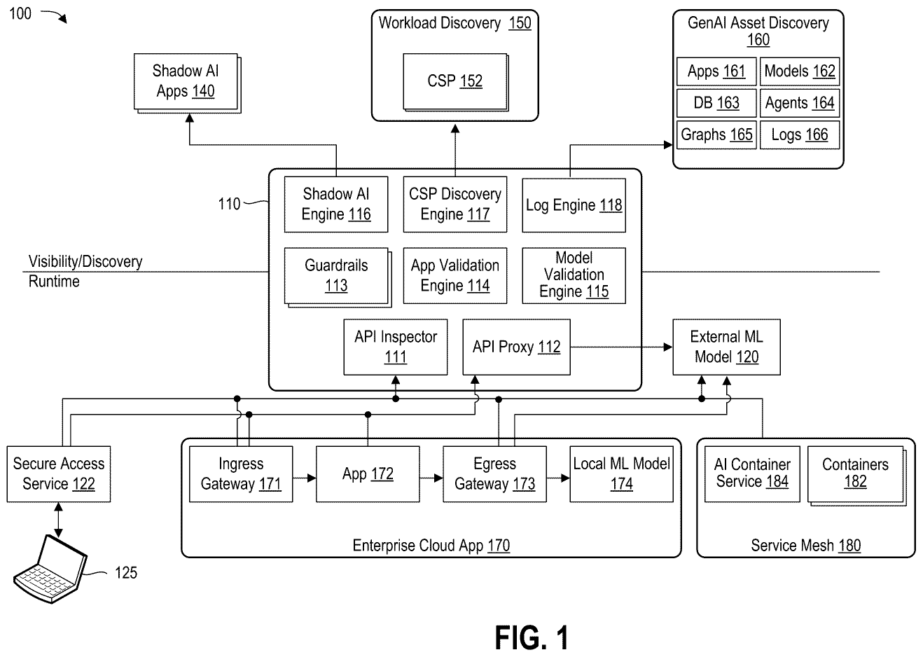

FIG. 1 is a conceptual block diagram of an AI defense controller system 100 in accordance with some aspects of the disclosure. In some aspects, the AI defense controller system 100 includes an AI defense controller 110 that is configured to transparently and securely inspect ingress and egress information to and from various ML and AI-based services. In some aspects, ML and AI herein may be used interchangeably to indicate non-deterministic processes performed by ML models including neural networks to apply learning based on various types of training. ML models (or AI models) can be relatively simple models (e.g., thousands of parameters such as a classifier) that can operate at line speed or can be large language models (LLMs) that have billions of parameters that use complex calculations to infer based on previous learning.

The AI defense controller 110 includes an application programming interface (API) inspector 111 and an API proxy 112 that interface with various components of an enterprise network. The AI defense controller 110 also includes at least one guardrail 113, which is a set of rules to invoke to ascertain safety of a request or response, identify potential data leakage, and so forth. In some aspects, the AI defense controller 110 also includes an application validation engine 114, a model validation engine 115, a shadow AI engine 116, a cloud service provider (CSP) discovery engine 117, and a log engine 118.

In some aspects, the AI defense controller 110 is configured to operate a runtime to handle network requests to perform various network security functions. For example, the API inspector 111 is configured to perform API request inspection by analyzing API requests for security threats, anomalies, and compliance issues without altering network flow. In some aspects, a secure access service 122 (e.g., a VPN user connected to an enterprise network) is configured to interface with an endpoint user 125 and may send an API request to the API inspector 111 to determine if the network user (e.g., the endpoint user 125) is permitted to access a particular destination address. The API inspector 111 may receive the request, which can include headers, a body, and execute one or more guardrails 113 to determine whether to allow or block the request. In some aspects, the AI defense controller 110 may also include an API proxy 112 to proxy network requests to manage, modify, and secure API requests between clients and backend services.

In some aspects, the guardrails 113 are sets of rules, heuristics, or models that are configured to analyze network requests of the AI defense controller 110. For example, a guardrail 113 can include conventional heuristic rules to allow/deny traffic, such as by rate-limiting input or output from an ML model. In some aspects, a guardrail 113 may also be an ML model that classify network data into various types of classifications, such as safe/not safe, malicious activity type, benign activity type, and so forth. For example, a guardrail 113 can be configured to identify code execution requests, which may be strictly forbidden, or a cross-site script (XSS) injection request, and so forth. The guardrail 113 can include a shallow path for an initial assessment of the contents of the packet and a deep path for a detailed assessment of the contents of the packet. For example, the shallow path can be performed on every packet and, when a packet is identified as potentially suspicious based on the guardrail 113, a deep path inspection can be invoked.

In some aspects, the AI defense controller 110 also includes a visibility/discovery phase for identifying assets and assessing those assets. The visibility/discovery phase includes an application validation engine 114 that is configured to assess application security posture. In some aspects, the application validation engine 114 is configured to inject a known repository of exploits and other malicious actions to determine if the application provides undesirable responses, indicating that the application is subject to potential exploits. In some aspects, application validation engine 114 can be integrated into a third-party platform to receive continuous updates to test internal or external applications. For example, native applications can be configured with a webview framework (e.g., Electron) that uses an hypertext markup language (HTML) renderer for rendering the application, and the application validation engine 114 may test various injection techniques (e.g., XSS, cascading style sheet (CSS) injections using pseudo-selectors such as :has( ), etc.).

The AI defense controller 110 can also include a model validation engine 115 configured to inject a known repository of exploits and other malicious actions to determine if an ML model provides undesirable responses, indicating that the model is subject to potential exploits. Similar to the application validation engine 114, the model validation engine 115 can be integrated into a third-party platform to receive continuous updates to test internal or external models.

The application validation engine 114 and the model validation engine 115 are continually evolving to add new threats and malicious acts and provide a significant volume of information that can be used to identify weaknesses and other potential attack vectors. In some cases, the responses from targets of the application validation engine 114 and the model validation engine 115 can be used to generate a repository of information and identify characteristics representative of attacks on models and applications. In turn, the AI defense controller 110 can use the characteristics representative of attacks to continually adapt the guardrail 113 to identify malicious acts and data exfiltration attempts.

The shadow AI engine 116 is configured to detect unsanctioned usage of one at least one shadow AI application 140 and record data pertaining to usage of that shadow AI application 140. In some aspects, a shadow AI application 140 is an unsanctioned model that is being used and is able to be accessed through an interface. For example, CSPs can enable access to an ML service (e.g., OpenAI, Anthropic, etc.) via a gateway that handles certain traffic mechanisms (e.g., retry mechanisms such as circuit breakers) and ensure correct service, such as a streaming response. In some aspects, the shadow AI engine 116 is configured to identify usage of the shadow AI application 140 and records information pertaining to its usage, such as recording headers, payloads, and responses. In some cases, the shadow AI engine 116 may detect a request to an unauthorized domain and redirect usage through an unsupported interface (e.g., the CSP gateway) to allow the shadow AI engine 116 to record information pertaining to the usage of the model.

In some aspects, the shadow AI engine 116 is also configured to detect the usage of a model by other applications. In many cases, current applications are employing API access to ML services to reduce heavy data entry, improve authentication, and provide enhanced user experiences. For example, the shadow AI engine 116 can detect when such applications are employing indirect access to ML models based on signatures in responses, or natural language in network requests.

In some aspects, the AI defense controller 110 includes a workload discovery service 150 using a CSP discovery engine 117. In some aspects, the CSP discovery engine 117 is configured to connect to one or more CSPs 152 to inspect for services, models, agents, and workloads that are available to the AI defense controller 110. The CSP discovery engine 117 identifies allocated virtual private cloud (VPC) instances and allows the AI defense controller 110 to dynamically build a repository of applications and services that are exposed to the AI defense controller 110 without requiring explicit configuration. The CSP discovery engine employs a combination of heuristics and models to identify various endpoints and models.

The AI defense controller 110 also includes a log engine 118 to implement a generative AI asset discovery service 160 that connects various services. In some aspects, the generative AI asset discovery service 160 includes application module 161 to scan and identify applications that make use of generative AI services based on API usage, library dependencies, or prompt patterns. The generative AI asset discovery service 160 may include a model inventor 162 to catalogue all detected AI models along with metadata such as their names, versions, hosting locations, and, if available, information about their training data. In some cases, database 163 (e.g., vector databases, relational databases, document databases, etc.), may identify and track databases associated with generative AI systems, such as vector databases, relational databases storing embeddings, and document databases used for storing prompts and responses. The generative AI asset discovery service 160 includes an agent module 164 to detect autonomous agents (e.g., AutoGPT instances or LangChain-based systems) and mapping their tasks, memory storage, and external interactions. A graph service 165 may reconstruct or detect knowledge graphs generated by AI models or retrieval-augmented generation (RAG) systems by identifying relationships between data entities. The generative AI asset discovery service 160 may also include CSP logs 166 that connects to the various CSPs and identifies ML-based usage. For example, the log engine 118 is configured to access CSP logs 166 and inspect the logs 166 for generative AI application usage. For example, the log engine 118 may access domain name server (DNS) logs, access logs, flow logs, model logs, and so forth. In some aspects, the various logs can surface information that be analyzed for natural language queries and corresponding responses to the natural language queries.

The AI defense controller 110 can be integrated at multiple levels to provide a holistic view of the usage of AI and ML-based functions and defensive coordination at different levels of abstraction. For example, the endpoint user 125 (e.g., a VPN user) can request the API inspector 111 for permission to access an external ML model 120 or API proxy 112 to proxy the request to the external ML model 120.

The AI defense controller 110 can also be integrated into an enterprise cloud application 170 that is configured in heterogeneous CSP services. The enterprise cloud application 170 may be integrated into a multicloud defense system that includes an ingress gateway 171 that is transparent and provides various security mechanisms, such as distributing consistent firewall configuration from a centralized control system (not shown). For example, the ingress gateway 171 may also include a web application firewall (WAF) configured for stateful inspection of requests and responses to an application 172. The ingress gateway 171 can also request a safety inspection of a request from the AI defense controller 110 using the guardrail 113.

The enterprise cloud application 170 may include an application 172 including generative AI features as part of an external ML model 120 or a local ML model 174 within the enterprise cloud application 170. For example, the external ML model 120 can be fine-tuned trained version of an ML model service (e.g., OpenAI, Anthropic, etc.) to provide public enterprise information to consumers of the application 172. Models can be trained to provide chatbot functions to assist customers in identifying products and services. In another example, external models can be trained based on real-time functions to provide voice interactivity for customer support functions, and so forth.

In some aspects, an egress gateway 173 can perform a stateful inspection of the requests from the application 172 to the external ML model 120 or the local ML model 174, using the API inspector 111 for example, to ensure that the prompts and information returned from the external ML model 120 or the local ML model 174 are safe and aligned with business purposes. In some cases, prompts can include malicious instructions to attempt to cause the external ML model 120 or the local ML model 174 to reveal proprietary information. The AI defense controller 110 identifies these malicious instructions and answers to those prompts to prevent unauthorized access to sensitive information. In some aspects, the AI defense controller 110 can also include guardrails 113 for training these models to ensure that proprietary information and personally identifiable information do not touch these models during fine-tuning. In some aspects, the egress gateway 173 may be configured in a pipeline with other components, such as inline inspection after the API proxy 112.

In some aspects, the AI defense controller 110 can be integrated into a service mesh 180 that is executed in various data centers. For example, the various services can be distributed across a plurality of containers 182 (e.g., Kubernetes) and a container service 184 that provides networking, observability, and security for container-based workloads. For example, the container service 184 may use an extended Berkeley Packet Filter (eBPF) to perform proxy, load balancing, authentication, and observability functions such as enforcing policies, performing deep packet inspection, and applying security rules to application traffic. The container service 184 can be integrated into the AI defense controller 110 to allow stateful AI defense such as denying and allowing traffic based on AI policies.

The AI defense controller 110 provides multiple integration points to allow stateful inspection of prompts and answers to those prompts. In some aspects, the AI defense controller 110 is configured to inspect prompts (e.g., in hypertext transfer protocol (HTTP) requests) to identify the safety of the prompts and inspect answers to those prompts, and identify the safety of the answers. The answers are a stream of data (e.g., a stream of HTTP responses) to allow inference operation to provide partial data based on the time-based nature of inference. The AI defense controller 110 is configured to analyzes the answer as the responses are being received to make a determination regarding the safety of the response. In some cases, the AI defense controller 110 can analyze the prompt and the response to determine the safety of the prompt and the response together.

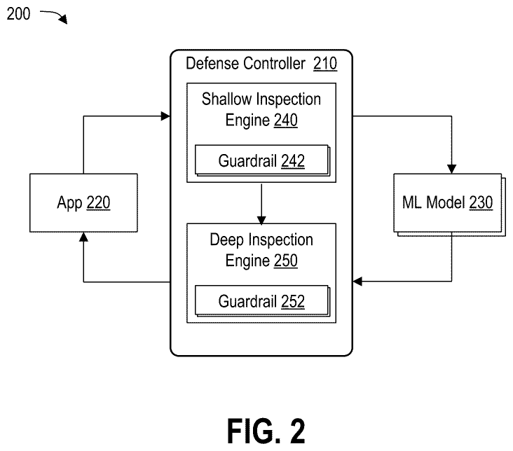

FIG. 2 is a conceptual diagram 200 of an inspection path of the AI defense controller system for ingress and egress traffic in accordance with some aspects of the disclosure. In some aspects, the defense controller 210 is configured to receive prompts from an application 220 that uses a ML model 230 (e.g., the external ML model 120 or the local ML model 174) for various operations. The application 220 can be a browser-based application (e.g., a front-end JavaScript bundle for rendering a user interface (UI)) or a native application that uses a network connection to access the ML model 230.

The application 220 is configured to send a request including a prompt to the defense controller 210 transparently. For example, the endpoint user 125 in FIG. 1 may request permission to send the request from an API inspector (e.g., the API proxy 112) or may send the request to an API proxy (e.g., the API proxy 112 in FIG. 1).

The defense controller 210 includes a shallow inspection engine 240 that is configured to analyze the request using one or more guardrails 242. For example, the guardrails include a combination of heuristic and model-based functions that are trained to identify safety. In one example, the guardrails may be configured to identify signatures that represent patterns associated with safe and unsafe prompts. The guardrails 242 renders a safety verdict to determine whether the prompt is safe or whether a detailed analysis of the prompt should be performed.

In some aspects, when the guardrails 242 identify potentially unsafe or malicious prompts, a deep inspection engine 250 is invoked to use one or more guardrails 252. In some aspects, the guardrails 252 of the deep inspection engine 250 provide a comprehensive review of the prompt to ensure that the shallow inspection engine 240 does not provide a false positive. For example, the deep inspection engine 250 may include a large language model or a reasoning ML model that can identify a reason that a particular prompt was denied, such as an attempt to retrieve external node and injected that code into a prompt or a response. To the extent the deep inspection engine 250 identifies a malicious prompt, the deep inspection engine 250 may deny transmission of the prompt and record information pertaining to the prompt. To the extent that the deep inspection engine 250 identifies a potentially malicious prompt, the deep inspection engine 250 may log the prompt for subsequent analysis and permit the prompt, subject to additional inspection of the response. In some cases, malicious prompts can be converted into probes or test cases to allow components of the defense controller 210 (e.g., the application validation engine 114 and the model validation engine 115) to probe services, applications, and models.

The ML model 230 may provide a response including a portion of an answer to permitted prompts. The defense controller 210 is configured to inspect the answer using the shallow inspection engine 240 and the deep inspection engine 250 similar to the prompt. In some aspects, the inspection of the answer from the ML model 230 may be stateful and ensure that the prompt and the answer are sufficiently related. For example, an answer generally incorporates features of a prompt, and failure to incorporate any feature may be an indication of hijacking of the prompt or bootstrapping of other information into the prompt to generate an unsafe or malicious response.

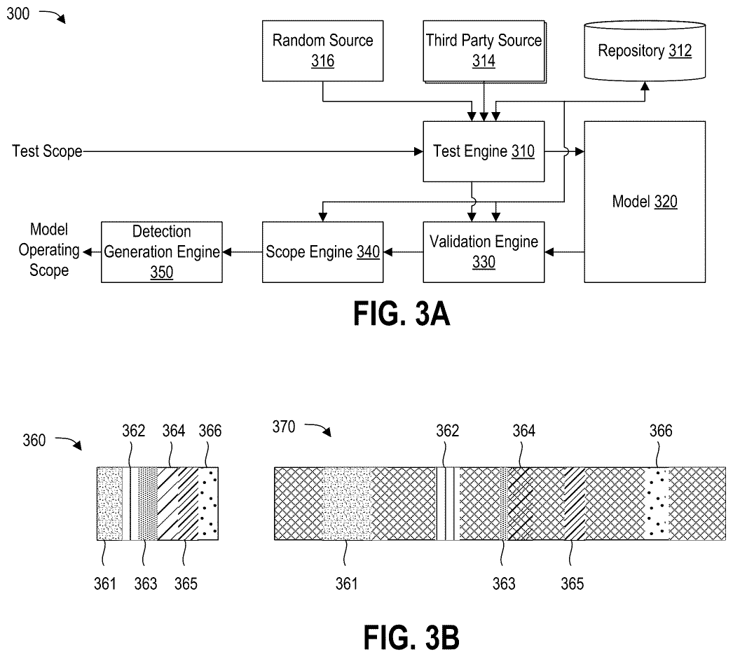

FIG. 3A is a block diagram of an ML validation system 300 in accordance with some aspects of the disclosure. In some aspects, the ML validation system 300 includes a test engine 310, an ML model 320, a validation engine 330, a scope engine 340 to receive testing scope and generate model operating scope of the ML model 320, and a detection generation engine 350 in accordance with some aspects of the disclosure. In some aspects, the ML validation system 300 may identify adverse ML usage and generate information such as patterns, classifiers, or other analysis engines to identify adverse prompts and/or adverse responses. In some aspects, the ML validation system 300 may generate information that can be deployed in an AI defense control system. For example, the ML validation system 300 may be used to develop a guardrail (e.g., a guardrail 242 or guardrail 252 of FIG. 2) to detect inline natural language prompts and responses.

In some aspects, the testing scope is the input parameters to test the ML model 320. For example, in some cases, a full evaluation is not requested and particular tests may be executed. In other cases, the test scope can be specific tests to iterate test development and other aspects of building a comprehensive ML model evaluation. The test engine 310 is connected to a repository 312 of ML tests and validation mechanisms. The repository 312 stores a variety of information, such as specific tests, pseudo-random tests, as well as testing information of the ML model 320. The test engine 310 may also be integrated with at least one third party service 314 to receive security information pertaining to ML models, security alerts, third-party security services, and so forth. For example, the test engine 310 may receive security alerts pertaining to the ML model 320 and the test engine 310 may access the repository 312 to identify relevant testing associated with an alert. In this case, the test engine 310 may be able to identify outdated model analysis based on autonomous information to allow the test engine 310 to surface security information and adapt security posture dynamically. The test engine 310 may also use the security information from the third party service 314 to add generated testing or information related to developing additional testing to be added to the repository 312, as well as validation information associated with the security information. In some aspects, various tests may be randomly modified to create additional noise and diversity associated with tests and a random source 316 can introduce random information to modify various tests. For example, the random information can be used to mutate a test to inject different information to add testing diversity.

The test engine 310 generates a plurality of tests to apply to the ML model 320 and then applies each test to the ML model 320 in an unstateful or stateless (e.g., single tests that are not related to prior or subsequent tests) or stateful manner (e.g., a plurality of tests tied together in a sequential manner). The tests may include a variety of information and multimodal content, such as images, audio, software instructions, to attempt to retrieve an unauthorized response (or an unsafe response) that does not comply with one or more policies. In some aspects, the ML model 320 may be a local ML model (e.g., retrieved from a remote source such as HuggingFace) executing on local hardware (e.g. within a private network). In other aspects, the ML model 320 may be remote and accessed using public network infrastructure, for example an ML associated with a custom trained model using a low rank adapter (LoRA) on a default model of external cloud computing service.

In some aspects, the test engine 310 may be configured to send a prompt (e.g., generated by the test engine 310) to the validation engine 330 for analysis. In some cases, the repository 312 can store unsafe or unauthorized prompts for analysis by the validation engine 330 prior to input into the ML model 320. For example, the test engine 310 may apply adverse prompts to the ML model that are known to provide an undesirable response. As further described below, the validation engine 330 can also analyze the response from the ML model 320 to determine whether the response is an undesirable response (e.g., unsafe or unauthorized). In some case, the adverse prompts and undesirable response may be mapped using a direction relationship. However, in other cases, the adverse prompts and undesirable responses may be uncoupled.

In some aspects, the test engine 310 may also be configured test the ML model 320 for malware. For example, the ML model 320 may be distributed in a package, and the package itself can include malicious content (e.g., a virus, malware, etc.).

The model 320 provides a response based on each test and a validation engine 330 is configured to validate the response. In some aspects, the repository 312 may store responses associated with an unsafe or unauthorized response. For example, the repository 312 may store an unauthorized response associated with the test that the validation engine 330 uses to compare with the response and determine a correlation of the response and the unsafe or unauthorized response. In some cases, the analysis may be simple, such as detecting a command corresponding to “rm -rf/” which will wipe an entire storage device. In other cases, the analysis may require complex instrumentation, such as identification of features that are unlawful (e.g., image manipulation) or suggestive content that would be unlawful or otherwise objectively harmful.

The validation engine 330 provides validation of the various tests to a scope engine 340 to identify a scope permitted by the ML model 320. For example, based on identification of a response corresponding to an unsafe or unauthorized response, the scope engine 340 may use information from the repository 312 to identify features of the ML model 320 that are not permitted. In one aspect, the scope engine 340 may use embeddings generated by the validation engine 330 to develop features to identify prompts and responses that are not permitted on an individual model's basis. In other aspects, the scope engine 340 may also include relationship functions to identify related models. For example, a LoRA will change some responses based on the connections at various layers and identification of particular features that invoke its execution. However, every weight is necessarily invoked that has a meaningful impact in the ML model, and relationships to other models can be identified. Fine-tuning can also be identified based on the types of inputs as well. The scope engine 340 outputs the model operating scope that defines regions in a multidimensional space that indicates specific features that indicate an unauthorized or an unsafe response.

In some aspects, the detection generation engine 350 is configured to receive the model operating scope from the scope engine 340 and generate information for identification of a prompt corresponding to the unsafe or unauthorized response. In one aspect, the detection generation engine 350 may train a moderation classifier that classifies prompts and responses based on embeddings of the prompt and/or response. In another aspect, the detection generation engine 350 is configured to identify patterns associated with the prompt based on the embeddings. In some aspects, various types of transformations can be applied to the embeddings to generate complex pattern identification information, such as a Fourier transform mapped into different dimensions (e.g., a toroid or a finite field).

FIG. 3B is a conceptual illustration of a signature matching pattern and a signature 360 of a prompt in accordance with some aspects of the disclosure. In some aspects, the signature includes various patterns that can be identified across any dimension. For the purposes of illustration, the signature 360 includes six distinct matching regions for example region 361, region 362, region 363, region 364, region 365, and region 366. In some aspects, a validation engine (e.g., during a runtime operation such as a guardrail 242 in FIG. 2) may generate a signature 370 of a prompt and compare with the signature 360. In some aspects, the signature 370 may include additional content in addition to the six distinct matching regions 361-366. In this case, the signature may be identified as unsafe or unauthorized and sending the prompt or receiving the prompt may be denied.

In other aspects, the undesirable responses can be associated with clusters of embeddings. For example, the validation engine 330 may identify embeddings of interest, and identify that the embeddings are connected to a plurality of clusters that are identified as malicious based on that specific combination of embeddings.

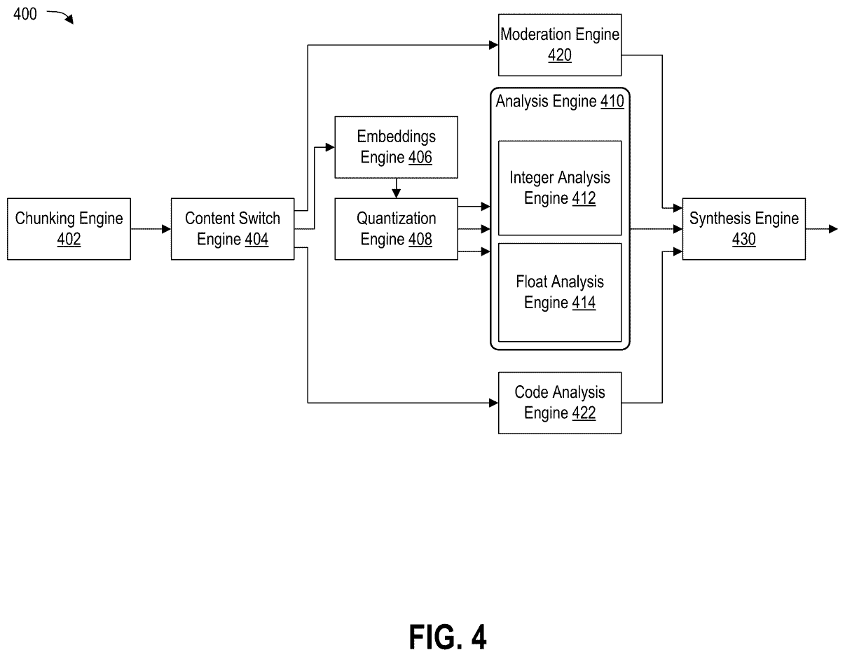

FIG. 4 is a block diagram of a validation engine of an ML validation system 400 (e.g. the validation engine 330 in FIG. 3A) in accordance with some aspects of the disclosure. In some aspects, the ML validation system 400 receives a prompt or a response, which is provided to a chunking engine 402. The chunking engine 402 is configured to identify portions to chunk based on various features, such as identification of code, different content modalities (e.g., audio, text, images, etc.) for embeddings. The various chunks are provided to a content switch engine 404 that is configured to identify the analysis path of the content as further described below.

In some aspects, natural language content, images, and audio can be provided to an embeddings engine 406 for conversion into embeddings in multidimensional space (e.g., 3072 vectors). The ML validation system 400 may provide the embeddings to a quantization engine 408 to quantize the embeddings in different forms (e.g., 16-bit floating point numbers, 8-bit integers, etc.). The embeddings are provided to an analysis engine 410 for a corresponding analysis. In some aspects, the analysis engine 410 includes an integer analysis engine 412 and a float analysis engine 414. The float analysis engine 414 is configured to compare the quantized or unquantized (e.g., in the case that the embeddings engine 406 outputs 32-bit floats) embeddings from the quantization engine 408 with features from a repository (e.g., the repository 312 in FIG. 3A) that correspond to unsafe or unauthorized content.

In some aspects, the integer analysis engine 412 is configured to compare the embeddings with features from a repository (e.g., the repository 312 in FIG. 3A) that are quantized into a corresponding integer domain to identify unsafe or unauthorized prompts/responses. In some aspects, vector conversion to the integer domain introduces additional noise, and a separate integer-based analysis of the prompt may be warranted based on the model itself. In some aspects, models themselves may be quantized, and the quantization into different forms allows analysis within the same domain as the model and provides better comparison results.

The content switch engine 404 may provide different chunks to other engines. In some aspects, each chunk may be provided to a moderation engine 420 (e.g., and ML model) that is configured to identify particular unsafe or unauthorized content. For example, the moderation engine 420 may be a custom model trained to identify sensitive information to an enterprise or government. In other cases, the moderation engine 420 may identify personally identifiable information. The content switch engine 404 may also provide code, machine-formatted data (e.g., XML or JSON), or instructions to the code analysis engine 422 to analyze the safety of the content. Similar to the code analysis engine 422 code analysis engine 422 identifies unsafe or unauthorized content. In some aspects, the code analysis engine 422 code analysis engine 422 may execute instructions in a virtualized environment to test for modifications of the virtualized environment by the code.

The information from the analysis engine 410, the moderation engine 420, and the code analysis engine 422 code analysis engine 422 and provided to a synthesis engine 430 to ascertain a synthesized safety information based on the analysis. In some aspects, the synthesis engine 430 may output the synthesized safety information, as well as the various forms of embeddings and any other content generated in the analysis of the prompt/response for consideration by a detection generation engine (e.g., the detection generation engine 350 in FIG. 3A).

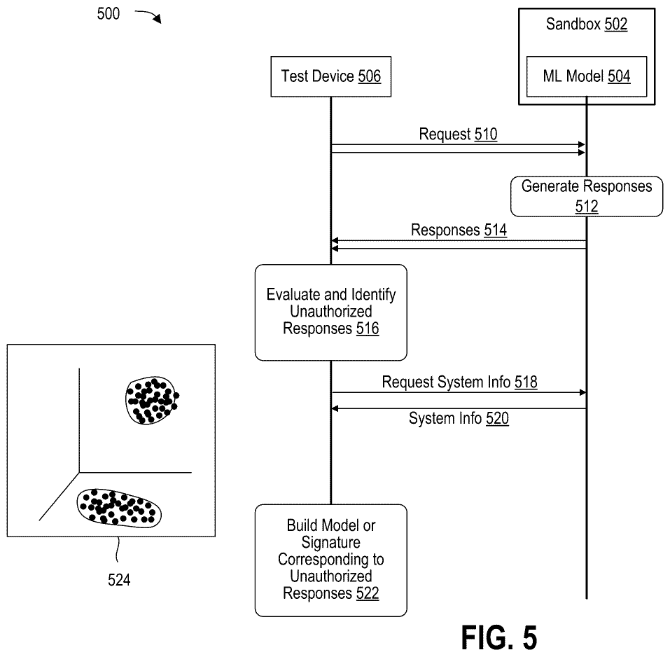

FIG. 5 is a sequence diagram 500 for preventing unauthorized ML model usage in accordance with some aspects of the disclosure. In some aspects, a sandbox environment 502 is provided (e.g., a virtual machine, a container, etc.) with an ML model 504. The sandbox environment 502 is configured to allow extraction of a portion of information generated by the ML model 504. For example, a test device 506 can trigger the sandbox environment 502 by sending a plurality of requests 510.

In some aspects, the requests 510 are adverse prompts from a collection of adverse prompts that attempt to trigger an undesirable response. For example, a portion of the collection of adverse prompts can be provided by associated with a third-party service (e.g., Talos, etc.) that distributes security information. At block 512, the ML model may generate response 514 and provide the responses 514 (either directly or indirectly) to the test device 506. For example, an indirect response is provided by storing the response locally in the sandbox environment 502, which the test device 506 can retrieve from an API call.

At block 516, the test device 506 is configured to evaluate and identify unauthorized responses from the ML model 504. For example, if the ML model 504 is not resilient towards a new type of injection attack, such as using pseudo-cascading style sheet (pseudo-CSS) selectors (e.g., :has( ), etc.), the ML model 504 evaluates the responses to identify an adverse response.

In some aspects, the test device 506 can also, concurrently with providing the requests 510, send requests for system information 518. For example, the test device 506 can request runtime information associated with the ML model 504, such as ML model state information. One type of ML model state information is a system prompt that may not be externally available and corresponds to a context associated with the ML model 504. In some cases, attacks may attempt to overwrite system prompts to place the ML model 504 in a different state to various purposes. For example, the system prompt can be overwritten to request explicit training information (e.g., data exfiltration, etc.). The ML model 504 provides the system information 520.

The test device 506 is configured to use the state information and the responses to identify whether the ML model 504 is susceptible to any of the attacks in the collection of adverse prompts. The test device 506 may include a model or heuristics capable to generating a model or signature associated with the adverse prompts at block 522. For example, the test device 506 may generate a collection of embeddings 524 associated with the adverse responses, which can be mapped to information associated with the adverse prompt. During runtime, the collection of embeddings can be used to identify responses that are similar to the collection of embeddings 524, which indicates the response is potentially malicious.

In this case, the test device 506 can build signatures and model for runtime protection of ML model responses to prevent unauthorized actions from being taken. For example, the signatures and models can prevent code injection attacks, data leakage, and so forth based on malicious prompts and prompt injection.

In some aspects, the sandbox environment 502 can also be used to identify malicious acts performed within the sandboxed environment by the ML model 504. For example, the ML model 504 may attempt to gain shell access based on a zero day exploit and send information to malicious addresses. The test device 506 may detect that the sandboxed environment has been modified by the ML model 504 and thereby provide a warning or other suitable output of the ML model 504.

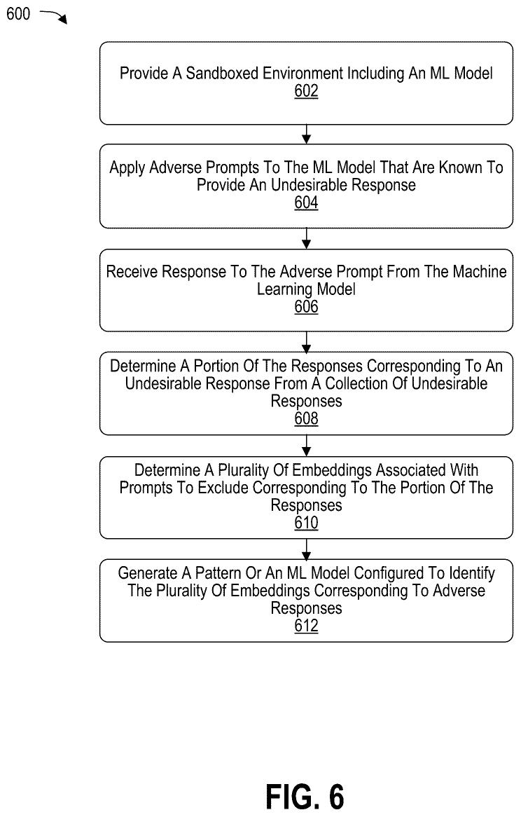

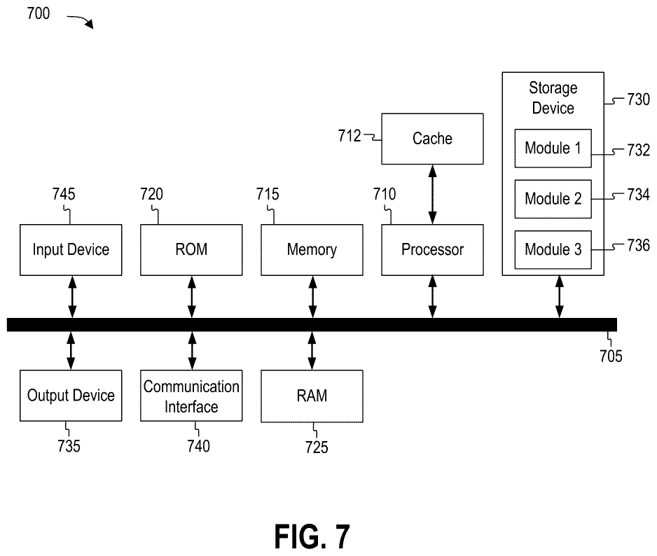

FIG. 6 is a flowchart illustrating an example process for generating ML authorization information for a multicloud system in accordance with some aspects of the disclosure. The process 600 can be performed by a computing device (or apparatus) or a component (e.g., one or more chipsets, an SoC, one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 600 may be implemented as software components that are executed and run on one or more processors (e.g., CPU, GPU, DSP, NPU or neural engine, SoC, the processor 710 of FIG. 7, and/or other processor(s)).

At block 602, the computing device may provide a sandboxed environment including an ML model.

At block 604, the computing device may apply adverse prompts to the ML model that are known to provide an undesirable response.

At block 606, the computing device may receive response to the adverse prompt from the machine learning model.

At block 608, the computing device may determine a portion of the responses corresponding to an undesirable response from a collection of undesirable responses. In some aspects, as part of block 608, the computing device may determine embeddings from the response, and determine a similarity of the embeddings to embeddings associated with the collection of undesirable responses. For example, the collection of adverse prompts can include a collection of undesirable responses, and the collection of undesirable responses can be converted into embeddings to identify similar responses.

In some cases, the similar responses can also be identified based on objective checks, such as hashes associated with particular instructions or content. For example, the undesirable responses can include code which generates a deterministic hash. The deterministic hash can be identified based on an equality match.

In some aspects, the computing device may also identify a group of embeddings corresponding to the response and identify the undesirable response based on the group of embeddings. In another aspect, the computing device may identify a plurality of clusters associated with the response based on a similarity. In this case, the undesirable response represents an arrangement of the plurality of clusters and is associated with a particular vulnerability.

In some aspects, the computing device may also identify a cluster associated with the response based on a similarity. In this aspect, the undesirable response represents the cluster and is associated with a particular vulnerability.

At block 610, the computing device may determine a plurality of embeddings associated with prompts to exclude corresponding to the portion of the responses.

At block 612, the computing device may generate a pattern or an ML model configured to identify the plurality of embeddings corresponding to adverse responses.

In some aspects, the computing device may also scan a package file including the machine learning model for malicious patterns. For example, the computing device may identify malicious instructions that can compromise a system executing the ML model. In some other cases, the computing device can also identify changes to the sandboxed environment that are unauthorized by the ML model itself (e.g., opening a port, sending a message to an unauthorized destination, etc.).

In some aspects, the computing device may also relate model families. For example, the computing device may identify a pretrained model corresponding to the ML model; and update a signature or a model corresponding to pretrained ML model.

In some aspects, the pattern or the ML model is configured to identify authorized prompts to the ML model.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some embodiments, computing system 700 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 700 includes at least one processing unit (CPU or processor) 710 and connection 705 that communicatively couples various system components including system memory 715, such as ROM 720 and RAM 725 to processor 710. Computing system 700 may include a cache 712 of high-speed memory connected directly with, in close proximity to, or integrated as part of processor 710.

Processor 710 may include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some embodiments, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”)symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method of generating protective services for ML models, comprising: providing a sandboxed environment including an ML model; applying adverse prompts to the ML model that are known to provide an undesirable response; receiving response to the adverse prompt from the machine learning model; determining a portion of the responses corresponding to an undesirable response from a collection of undesirable responses; and determining a plurality of embeddings associated with prompts to exclude corresponding to the portion of the responses; and generating a pattern or an ML model configured to identify the plurality of embeddings corresponding to adverse responses.

Aspect 2. The method of Aspect 1, determining whether the response corresponds to an undesirable response comprises: determining embeddings from the response; determining a similarity of the embeddings to embeddings associated with the collection of undesirable responses.

Aspect 3. The method of any of Aspects 1 to 2, further comprising: identifying a group of embeddings corresponding to the response; and identifying the undesirable response based on the group of embeddings.

Aspect 4. The method of any of Aspects 1 to 3, further comprising: identifying a cluster associated with the response based on a similarity, wherein the undesirable response represents the cluster and is associated with a particular vulnerability.

Aspect 5. The method of any of Aspects 1 to 4, further comprising: identifying a plurality of cluster associated with the response based on a similarity, wherein the undesirable response represents an arrangement associated with the plurality of clusters and is associated with a particular vulnerability.

Aspect 6. The method of any of Aspects 1 to 5, further comprising: scanning a package file including the machine learning model for malicious patterns.

Aspect 7. The method of any of Aspects 1 to 6, further comprising: identifying a pretrained model corresponding to the ML model; and updating a signature or a model corresponding to pretrained ML model.

Aspect 8. The method of any of Aspects 1 to 7, wherein the pattern or the ML model is configured to identify authorized prompts to the ML model.

Aspect 9. A computing device for generating protective services for machine learning ML models. The computing device includes at least one memory and at least one processor coupled to the at least one memory and configured to: provide a sandboxed environment including an ML model; apply adverse prompts to the ML model that are known to provide an undesirable response; receive a response to the adverse prompt from the machine learning model; determine a portion of the responses corresponding to an undesirable response from a collection of undesirable responses; determine a plurality of embeddings associated with prompts to exclude corresponding to the portion of the responses; and generate a pattern or an ML model configured to identify the plurality of embeddings corresponding to adverse responses.

Aspect 10. The computing device of Aspect 9, wherein the at least one processor is configured to: determine embeddings from the response; determining a similarity of the embeddings to embeddings associated with the collection of undesirable responses.

Aspect 11. The computing device of any of Aspects 9 to 10, wherein the at least one processor is configured to: identify a group of embeddings corresponding to the response; and identifying the undesirable response based on the group of embeddings.

Aspect 12. The computing device of any of Aspects 9 to 11, wherein the at least one processor is configured to: identify a cluster associated with the response based on a similarity, wherein the undesirable response represents the cluster and is associated with a particular vulnerability.

Aspect 13. The computing device of any of Aspects 9 to 12, wherein the at least one processor is configured to: identify a plurality of cluster associated with the response based on a similarity, wherein the undesirable response represents an arrangement associated with the plurality of clusters and is associated with a particular vulnerability.

Aspect 14. The computing device of any of Aspects 9 to 13, wherein the at least one processor is configured to: scan a package file including the machine learning model for malicious patterns.

Aspect 15. The computing device of any of Aspects 9 to 14, wherein the at least one processor is configured to: identify a pretrained model corresponding to the ML model; and updating a signature or a model corresponding to pretrained ML model.

Aspect 16. The computing device of any of Aspects 9 to 15, wherein the pattern or the ML model is configured to identify authorized prompts to the ML model.

Aspect 17. A non-transitory computer readable medium for generating protective services for machine learning ML models. The computing device that executes the computer readable medium includes one or more memories and one or more processors coupled to the one or more memories. The computing device is configured to, when executing the computer readable medium to: provide a sandboxed environment including an ML model; apply adverse prompts to the ML model that are known to provide an undesirable response; receive response to the adverse prompt from the machine learning model; determine a portion of the responses corresponding to an undesirable response from a collection of undesirable responses; determine a plurality of embeddings associated with prompts to exclude corresponding to the portion of the responses; and generate a pattern or an ML model configured to identify the plurality of embeddings corresponding to adverse responses.

Aspect 18. The computer readable medium of Aspect 17, wherein the one or more processors are configured to: determine embeddings from the response; and determine a similarity of the embeddings to embeddings associated with the collection of undesirable responses.

Aspect 19. The computer readable medium of any of Aspects 17 to 18, wherein the one or more processors are configured to: identify a group of embeddings corresponding to the response; and identify the undesirable response based on the group of embeddings.

Aspect 20. The computer readable medium of any of Aspects 17 to 19, wherein the one or more processors are configured to: identify a cluster associated with the response based on a similarity, wherein the undesirable response represents the cluster and is associated with a particular vulnerability.

Aspect 21. The computer readable medium of any of Aspects 17 to 20, wherein the one or more processors are configured to: further comprising: identifying a plurality of cluster associated with the response based on a similarity, wherein the undesirable response represents an arrangement associated with the plurality of clusters and is associated with a particular vulnerability.

Aspect 22. The computer readable medium of any of Aspects 17 to 21, wherein the one or more processors are configured to: scan a package file including the machine learning model for malicious patterns.

Aspect 23. The computer readable medium of any of Aspects 17 to 22, wherein the one or more processors are configured to: identify a pretrained model corresponding to the ML model; and update a signature or a model corresponding to pretrained ML model.

Aspect 24. The computer readable medium of any of Aspects 17 to 23, wherein the pattern or the ML model is configured to identify authorized prompts to the ML model.

What is claimed is:

1. A method of generating protective services for machine learning (ML) models, comprising:
applying adverse prompts to an ML model that are known to provide an undesirable response;
receiving responses to the adverse prompts from the ML model;
determining a portion of the responses corresponding to an undesirable response from a collection of undesirable responses;
determining a plurality of embeddings associated with prompts to exclude corresponding to the portion of the responses; and
generating a pattern or an ML detection model configured to identify the plurality of embeddings corresponding to adverse responses.

2. The method of claim 1, determining whether the responses correspond to the undesirable response comprises:
determining embeddings from a corresponding response; and
determining a similarity of the embeddings to embeddings associated with the collection of undesirable responses.

3. The method of claim 1, further comprising:
identifying a group of embeddings corresponding to the responses; and
identifying the undesirable response based on the group of embeddings.

4. The method of claim 1, further comprising: identifying a cluster associated with the responses based on a similarity, wherein the undesirable response represents the cluster and is associated with a particular vulnerability.

5. The method of claim 1, further comprising: identifying a plurality of clusters associated with the responses based on a similarity, wherein the undesirable response represents an arrangement associated with the plurality of clusters and is associated with a particular vulnerability.

6. The method of claim 1, further comprising:
scanning a package file including the ML model for malicious patterns.

7. The method of claim 1, further comprising:
identifying a pretrained model corresponding to the ML model; and
updating a signature or a model corresponding to pretrained ML model.

8. The method of claim 1, wherein the pattern or the ML model is configured to identify authorized prompts to the ML model.

9. A computing device for generating protective services for ML models, comprising:
at least one memory; and
at least one processor coupled to the at least one memory and configured to:
apply adverse prompts to an ML model that are known to provide an undesirable response;
receive responses to the adverse prompts from the ML model;
determine a portion of the responses corresponding to the undesirable response from a collection of undesirable responses;
determine a plurality of embeddings associated with prompts to exclude corresponding to the portion of the responses; and
generate a pattern or an ML detection model configured to identify the plurality of embeddings corresponding to adverse responses.

10. The computing device of claim 9, wherein the at least one processor is configured to:
determine embeddings from a corresponding response; and
determine a similarity of the embeddings to embeddings associated with the collection of undesirable responses.

11. The computing device of claim 9, wherein the at least one processor is configured to:
identify a group of embeddings corresponding to the responses; and
identify the undesirable response based on the group of embeddings.

12. The computing device of claim 9, wherein the at least one processor is configured to:
identify a cluster associated with the responses based on a similarity, wherein the undesirable response represents the cluster and is associated with a particular vulnerability.

13. The computing device of claim 9, wherein the at least one processor is configured to:
identify a plurality of clusters associated with the responses based on a similarity, wherein the undesirable response represents an arrangement associated with the plurality of clusters and is associated with a particular vulnerability.

14. The computing device of claim 9, wherein the at least one processor is configured to:
scan a package file including the ML model for malicious patterns.

15. The computing device of claim 9, wherein the at least one processor is configured to:
identify a pretrained model corresponding to the ML model; and
update a signature or a model corresponding to pretrained ML model.

16. The computing device of claim 9, wherein the pattern or the ML model is configured to identify authorized prompts to the ML model.

17. A non-transitory computer readable medium for generating protective services for machine learning ML models, comprising instructions that, when executed by a processor, cause the processor to:
apply adverse prompts to an ML model that are known to provide an undesirable response;
receive responses to the adverse prompts from the ML model;
determine a portion of the responses corresponding to the undesirable response from a collection of undesirable responses;
determine a plurality of embeddings associated with prompts to exclude corresponding to the portion of the responses; and
generate a pattern or an ML detection model configured to identify the plurality of embeddings corresponding to adverse responses.

18. The computer readable medium of claim 17, wherein the instructions configure the processor to:
determine embeddings from the responses; and
determine a similarity of the embeddings to embeddings associated with the collection of undesirable responses.

19. The computer readable medium of claim 17, wherein the instructions configure the processor to:
identify a group of embeddings corresponding to the responses; and
identify the undesirable response based on the group of embeddings.

20. The computer readable medium of claim 17, wherein the instructions configure the processor to:
identify a cluster associated with the responses based on a similarity, wherein the undesirable response represents the cluster and is associated with a particular vulnerability.
